(19) United States
(12) Patent Application Publication
(10) Pub. No.: US 2007/0193703 A1
(43) Pub. Date: Aug. 23, 2007

(54) Window coverings string coiler

(76) Inventor: Li-Ming Cheng, Kaohsiung City (TW)

Correspondence Address: BIRCH STEWART KOLASCH & BIRCH, PO BOX 747, FALLS CHURCH, VA, 22040-0747, US

(21) Appl. No.: 11/356,035

(22) Filed: Feb. 17, 2006

(51) Int. Cl. E06B 9/388

(52) U.S. Cl. 160/173 R

(57) ABSTRACT

A Window coverings string coiler includes a hollow casing, a gear set, a string winding wheel set, two resilient plates, a synchronous control member, and a control set. The string winding wheel set and the gear set include first and second string winding wheels and first and second gears coupled with each other and also pivotally coupled to the interior of the casing. The synchronous control member is coupled to the first and second gears for controlling synchronous rotations. The control set controls the scrolling or opening operation of the blind vane, such that the first and second gears coupled to the string winding wheel set and the design of a synchronous control member for controlling the synchronous rotation of the first and second gears are used to achieve a consistent rotary speed of the first and second string winding wheels for coiling or releasing the pulling string.

### FIELD OF THE INVENTION

The present invention relates to a window coverings string coiler, and more particularly to a string coiler that can be installed at the position of a lower rail of a window coverings for providing a convenient way for users to scroll the blind up or down.

### BACKGROUND OF THE INVENTION

At present, a general Window coverings includes a set of an upper rail rest and a lower rail rest separated from each other, and a blind vane installed between the upper and lower rail rests and controlled by a plurality of pulling strings for scrolling up and down the blind vane to achieve a sun shading effect and provide a decorative function by installing the window coverings to a window or a door.

Referring to FIG. 1, a lower rail rest 21 of a general Window coverings 20 usually has a string coiler 10 connected to a pulling string for users to scroll or open a blind vane 22 of the Window coverings 20. In FIG. 2, the string coiler 10 comprises a hollow casing 11, a first string winding wheel 12, a second string winding wheel 13, two resilient plates 14, and a control set 15, wherein the first and second string winding wheels 12, 13 are pivotally coupled to the interior of the casing 11 for connecting the pulling strings 23, 24 of the Window coverings 20, and the two resilient plates 14 are embedded into the internal sides of the first and second string winding wheels 12, 13 respectively, and the control set 15 comprises a latch member 151, a push rod 152, and a spring 153. With the push rod 152 and the spring 153, the latch member 151 presses the pulling strings 21, 22 to prevent the pulling strings 21, 22 from moving or falling out.

Referring to the foregoing figures and FIG. 3, if a user wants to open the blind vane 22 of the Window coverings 20, the user will press the push rod 152 to separate the latch member 151 and allow the pulling strings 23, 24 to move, and then apply a force downward to open the blind vane 22 of the Window coverings 20. During the process of opening the blind vane 22, the two resilient plates 14 disposed at the first and second string winding wheels 12, 13 are elastically compressed, so that after the blind vane 22 is opened, the push rod 152 can be released by the resilient restoring action of the spring 153. Therefore, the latch member 151 will press and prevent the pulling string 21 from moving again. In FIG. 4, if the user wants to scroll the blind vane 22 of the Window coverings 20, the user will press the push rod 152 similarly, so that the latch member 151 will separate from the pulling strings 23, 24, and the two elastically compressed resilient plates 14 will use a resilient restoring action to drive the first and second string winding wheels 12, 13 to coil the pulling strings 23, 24. When the blind vane 22 reaches an expected height, the push rod 152 is released, so that the latch member 151 presses and prevents the pulling strings 23, 24 from moving, so as to complete the coiling of the blind vane 22.

However, the application of the string coiler 10 does not come with a synchronous design for controlling the first and second string winding wheels 12, 13, and thus the first and second string winding wheels 12, 13 may result an inconsistent rotary speed during the process of scrolling or releasing the pulling strings 23, 24, and thus resulting inconsistent positions on both sides of the upwardly scrolled or downwardly opened blind vane 22, and the decorative effect of the Window coverings 20 will be affected adversely, and the string coiler 10 will be damaged easily after a long time use of scrolling or opening the Window coverings 20.

### SUMMARY OF THE INVENTION

The primary objective of the present invention is to provide a Window coverings string coiler in hope of overcoming the shortcoming of a prior art string coiler that cannot rotate synchronously with the first and second string winding wheels for facilitating the scrolling or opening operation of the Window coverings.

To achieve the foregoing objective of the present invention, the technical measure taken by the invention provides a Window coverings string coiler that comprises a hollow casing, a gear set, a string winding wheel set, two resilient plates, a synchronous control member, and a control set; wherein the hollow casing includes two corresponding protruding pillars therein, an opening disposed separately on both ends, and a through hole formed on one side; the gear set includes a first gear and a second gear pivotally and respectively coupled to the two protruding pillars inside the casing; the string winding wheel set includes a first string winding wheel and a second string winding wheel respectively coupled to the first and second gears and pivotally coupled to the two protruding pillars, and each internal side of the first and second string winding wheels form a containing groove; the two resilient plates are placed into the containing grooves of the first and second string winding wheels, and the resilient plate has a first embedding end fixed to an internal side of the containing groove and a second embedding end of the protruding pillar; the synchronous control member is provided for connecting the first and second gears and controlling a synchronously rotating gear or belt; and the control set includes a latch member, a push rod, and a spring, and the latch member is installed inside the casing and disposed between the first and second string winding wheels, and a latch portion is extended separately from both sides of the corresponding first and second string winding wheels, and the push rod passes through the through hole of the casing for installing a spring and connecting a latch member, and an end of the spring is connected to the latch member, and another end of the spring presses against an internal side of the casing.

In the structural design of the foregoing Window coverings string coiler, the string coiler is installed at the lower rail of the Window coverings for users to scroll or open the blind vane. During the process of scrolling or opening the blind vane, the first and second gears respectively coupled to the first and second string winding wheels can control the first and second gears to be rotated synchronously by a synchronous control member, such that the rotary speed of the first and second string winding wheels will be the same during the process of coiling or releasing the pulling strings, so as to achieve the effects of preventing the blind vane of the Window coverings from being tilted after the blind vane is scrolled or opened and improving the life of the Window coverings.

### BRIEF DESCRIPTION OF THE DRAWINGS

FIG. 1 is a schematic view of a prior art string coiler installed to a Window coverings;

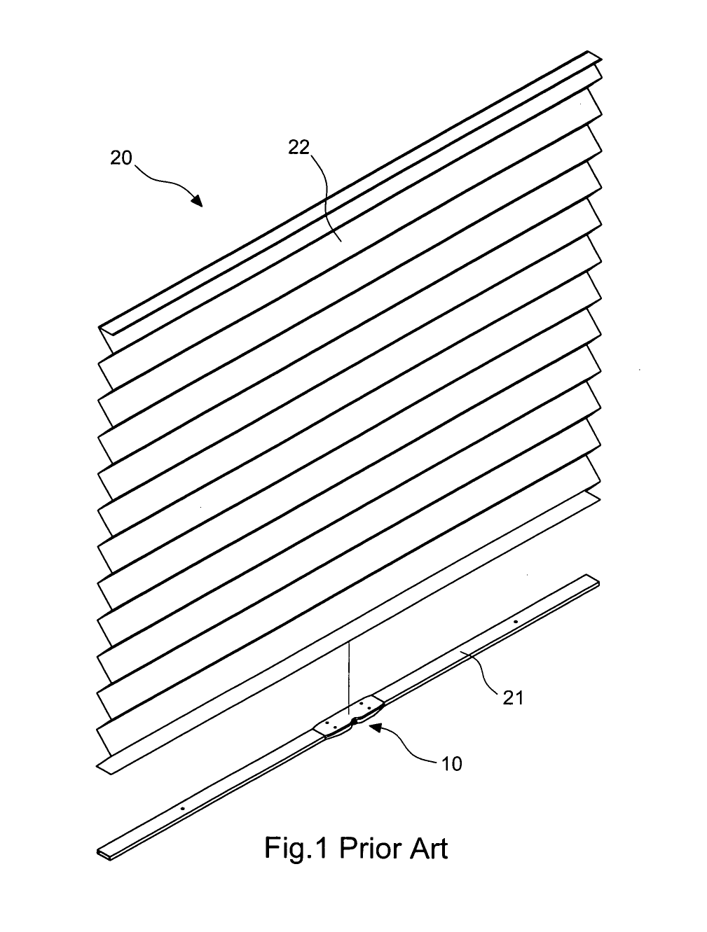

FIG. 2 is a cross-sectional view of a prior art string coiler;

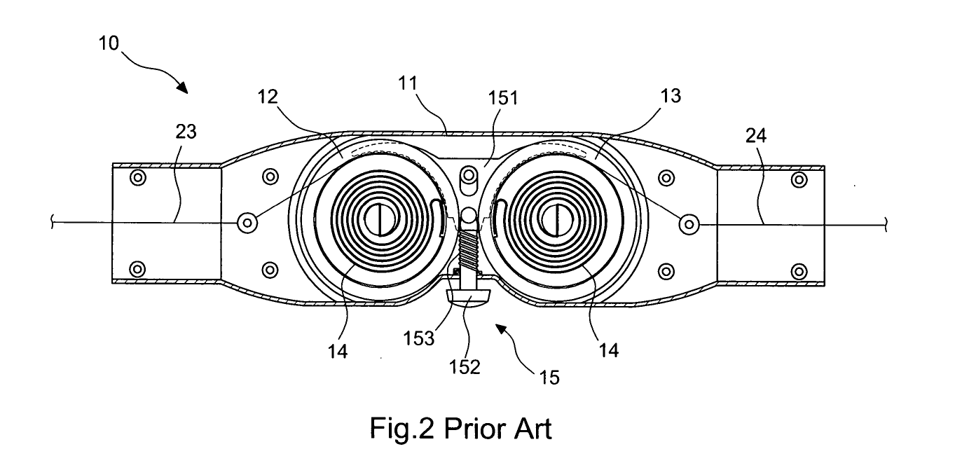

FIG. 3 is a schematic view of using a prior art string coiler;

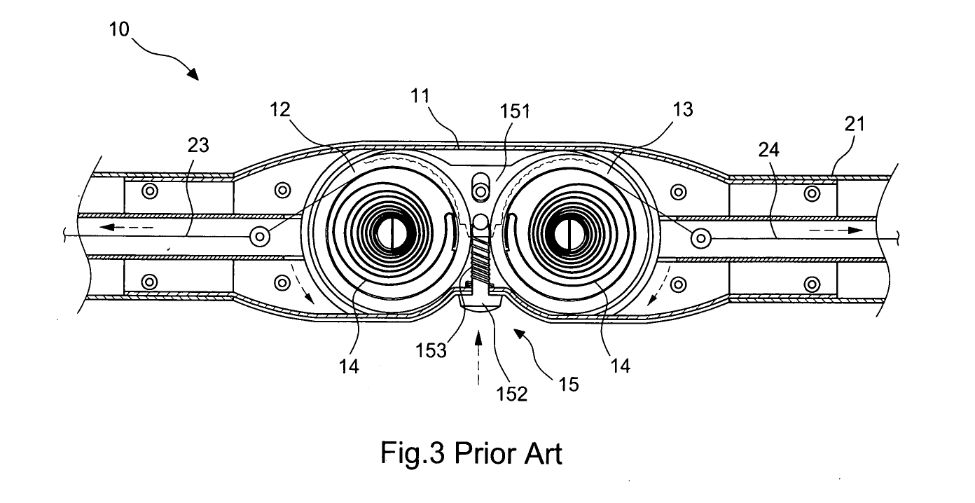

FIG. 4 is another schematic view of using a prior art string coiler;

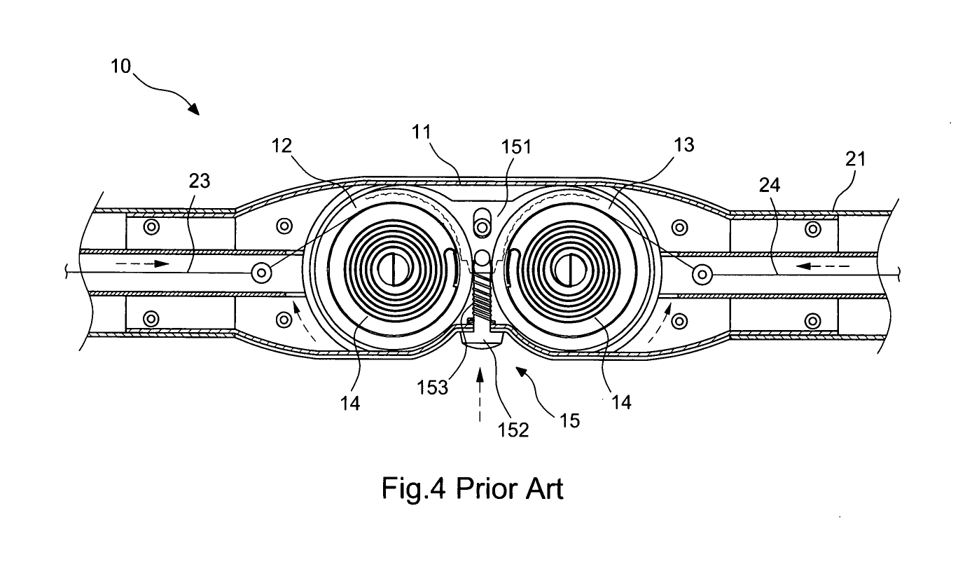

FIG. 5 is an exploded view of a string coiler of the invention;

FIG. 6 is a cross-sectional view of a string coiler of the invention;

FIG. 7 is a schematic view of a string coiler installed to a Window coverings according to the invention;

FIG. 8 is a schematic view of using a string coiler of the invention;

FIG. 9 is another schematic view of using a string coiler of the invention;

FIG. 10 is a schematic view of using a string coiler according to another preferred embodiment of the invention; and

FIG. 11 is another schematic view of using a string coiler according to another preferred embodiment of the invention;

### DETAILED DESCRIPTION OF THE PREFERRED EMBODIMENTS

The present invention will now be described in more detail hereinafter with reference to the accompanying drawings as follows:

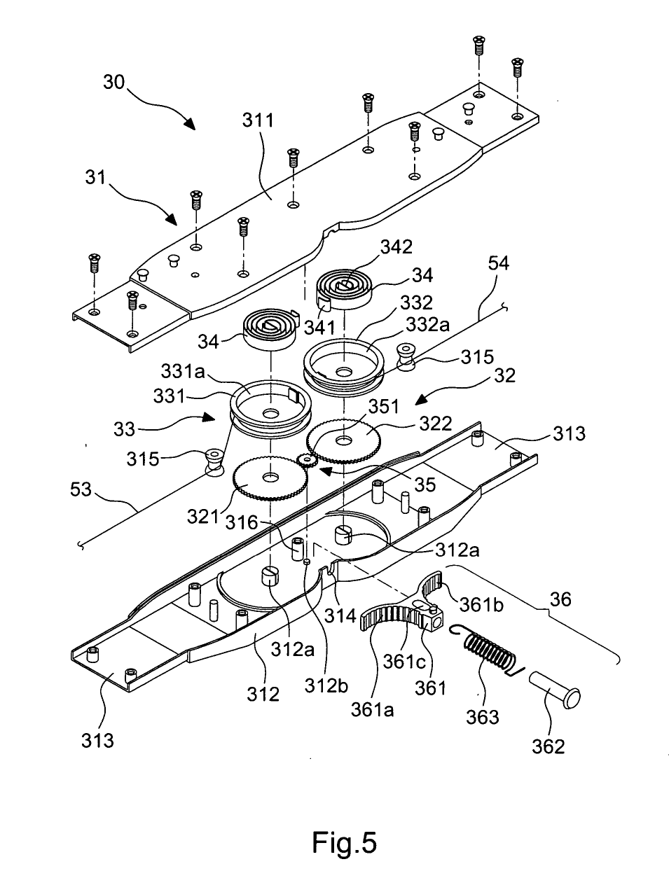

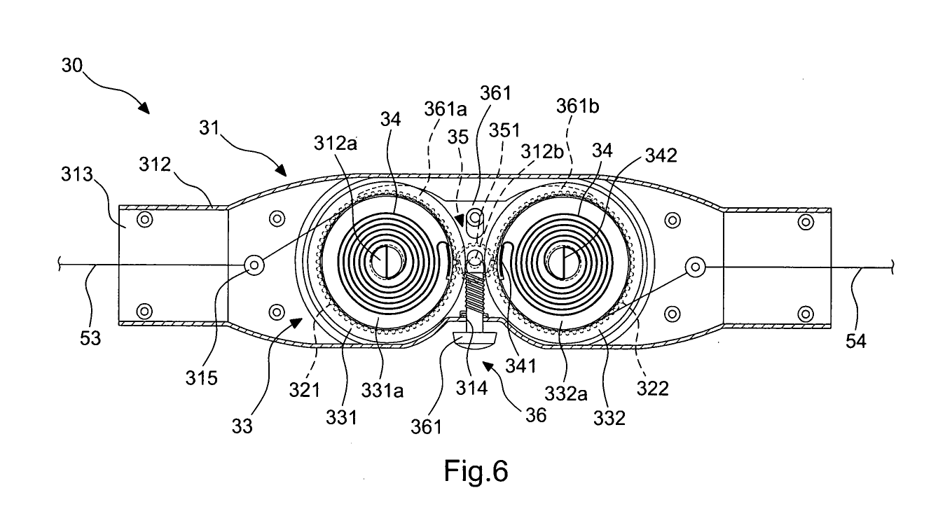

Referring to FIGS. 5 and 6, the Window coverings string coiler 30 of the invention comprises a hollow casing 31, a gear set 32, a string winding wheel set 33, two resilient plates 34, a synchronous control member 35, and a control set 36.

The casing 31 comprises an upper casing 311 and a lower casing 312 engaged with each other, and the lower casing 312 includes two corresponding protruding pillars 312a disposed on both lateral sides in the lower casing 312, a pivot 312b disposed between the two protruding pillar 312a, an opening 313 disposed separately on both sides of the casing 31 which is formed by engaging the upper and lower casings 311, 312, and a through hole 314 disposed on a lateral side.

The gear set 32 includes a first gear 321 and a second gear 322 coupled to two protruding pillars 312a of the casing 31 respectively.

The string winding wheel set 33 includes a first string winding wheel 331 and a second string winding wheel 332 respectively coupled to the first and second gears 321, 322 and pivotally coupled to the two protruding pillars 312a, and the first and second string winding wheels 331, 332 form a containing groove 331a, 332a separately on the internal sides of the first and second string winding wheels 331, 332.

The two resilient plates 34 are placed separately into the containing grooves 331a, 332a of the first and second string winding wheels 331, 332. The resilient plate 34 includes a first embedding end 341 to be fixed onto the internal walls of the containing grooves 331a, 332a and a second embedding end 342 to be fixed to the protruding pillar 312a.

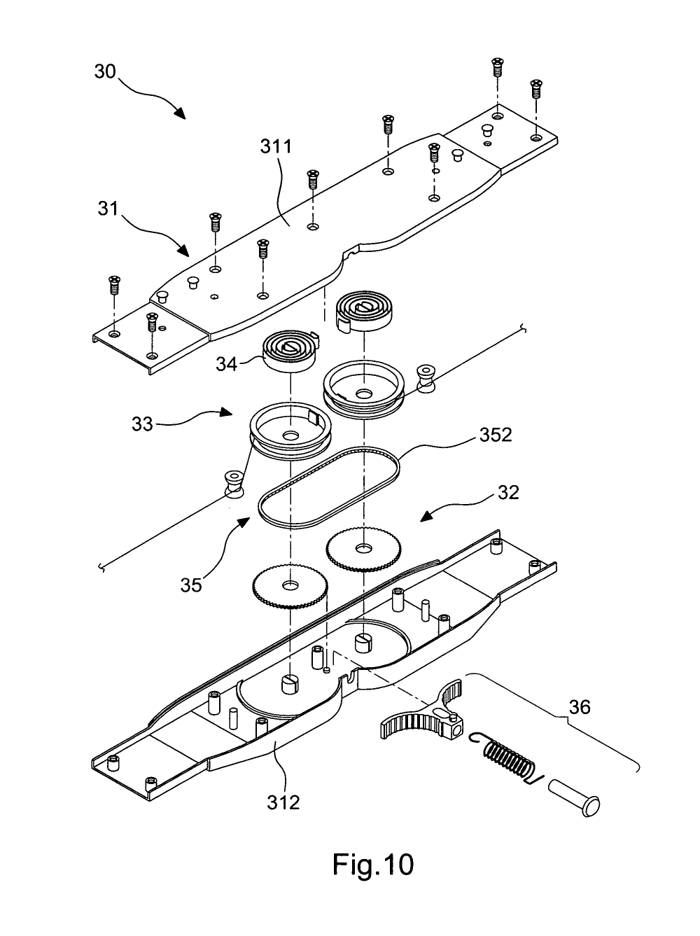

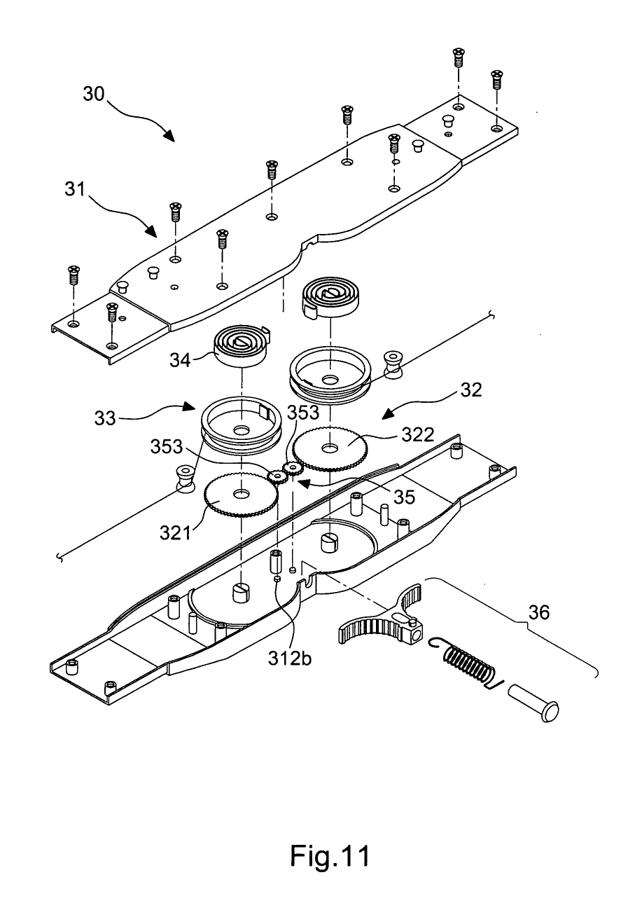

The synchronous control member 35 is provided for connecting the first and second gears 321, 322 and controlling their synchronous rotation. In a preferred embodiment as shown in FIG. 5, the synchronous control member 35 is a gear 351 separately engaged with the first and second gears 321, 322 and pivotally coupled to a pivot 312b of the casing 31 or the synchronous control member 35 are two mutually engaged gears 353 as shown in FIG. 11. The two gears 353 are engaged to the first and second gears 321, 322 respectively and the casing 31 similarly comprises two corresponding pivots 312b pivotally coupled to the two gears 353, such that when the first and second gears 321, 322 are rotated with the first and second string winding wheels 331, 332, synchronous rotations can be achieved by the engagement of the gears 351, 353. In FIG. 10, the synchronous control member 35 is a belt 352 connected to the first and second gears 321, 322 and thus similarly achieving the effect of controlling the first and second gears 321, 322 and the first and second string winding wheels 331, 332 to rotate synchronously.

The control set 36 includes a latch member 361, a push rod 362, and a spring 363, and the latch member 361 is installed inside the casing 31 and disposed between the first and second string winding wheels 331, 332, and a latch portion 361a, 361b is extended separately from both sides of the corresponding first and second string winding wheels 331, 332. The push rod 362 is passed through a through hole 314 of the casing 31 for installing the spring 363 thereon and coupled to the latch member 361. An end of the spring 363 is connected to the latch member 361, and another end of the latch member 361 presses an internal side of the casing 31.

In FIG. 5, the casing 31 includes a roller 315 separately disposed on both sides of the first and second string winding wheels 331, 332, such that when the first and second string winding wheels 321, 322 are coupled with the pulling strings 53, 54 of the Window coverings 50, the rollers 315 press the pulling strings 53, 54 to facilitate the coiling operation.

In FIG. 5, the casing 31 forms a positioning pillar 316 between the first and second string winding wheels 331, 332 inside the casing 31, and the latch member 361 forms a long penetrating hole 361c thereon for passing the positioning pillar 316 and limits the movement of the latch member 361 inside the casing 31.

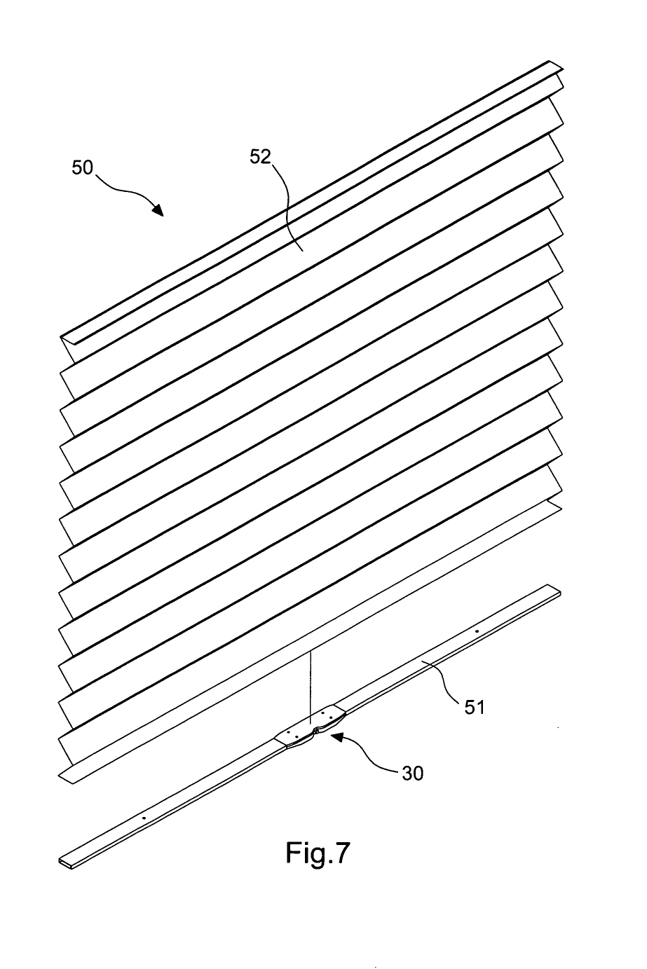

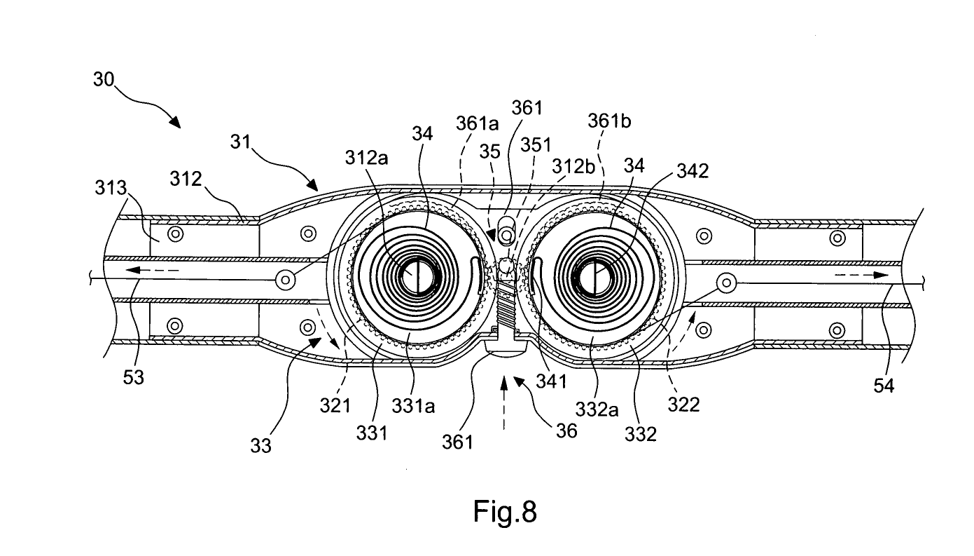

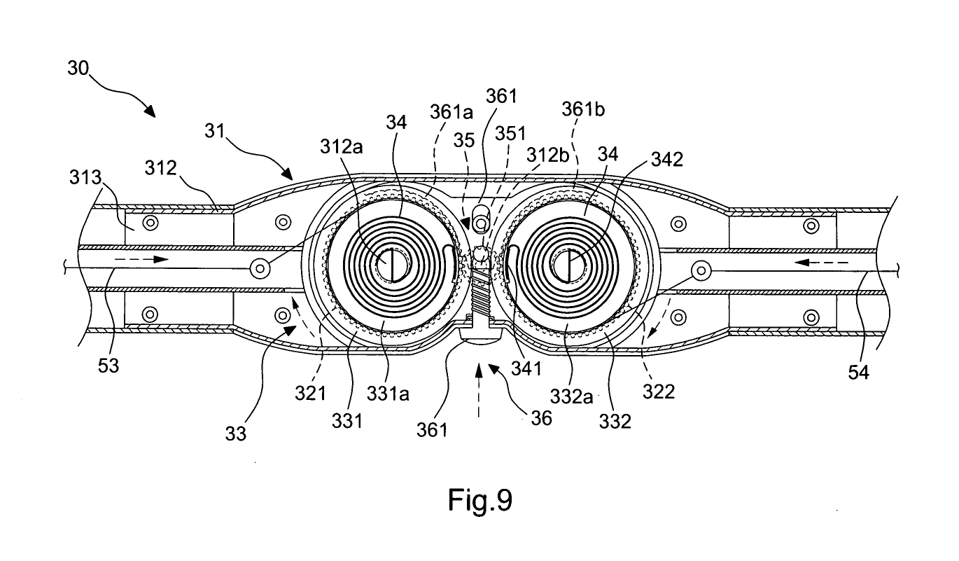

Referring to the foregoing figures and FIGS. 7 and 8, the string coiler 30 of the invention is installed at a position of a lower rail rest 51 of the Window coverings 50, and the first and second string winding wheels 321, 322 are provided for separately connecting the pulling strings 53, 54 of the Window coverings 50, and the pulling strings 53, 54 are passed through the openings 313 on both sides of the casing 31 respectively to connect the blind vane 52 (not shown in the figure) of the Window coverings 50, and the latch portions 361a, 361b of the latch member 361 are controlled and pressed by the pulling strings 53, 54 to prevent the pulling strings 53, 54 from moving or the pulling strings 53, 54 are controlled and separated, such that when a user wants to scroll down and open the blind vane 52 of the Window coverings 50, the user presses the push rod 362 to separate the latch member 361 from the pulling strings 53, 54 and allow the pulling strings 53, 54 to move, and then applies a force downward to open the blind vane 52 of the Window coverings 50. During the process of opening the blind vane 52, the two resilient plates 34 disposed at the internal sides of the first and second string winding wheels 331, 332 are elastically compressed, such that after the blind vane 52 is opened, the push rod 362 is released, and the resilient restoring force of the spring 363 drives the latch member 361 to press the pulling strings 53, 54 again to prevent the pulling strings 53, 54 from moving. In FIG. 9, if a user wants to roll up the blind vane 52 of the Window coverings 50, the user can similarly press the push rod 362 to separate the latch member 361 from the pulling strings 53, 54, and the two compressed resilient plates 34 use their resilient restoring force to drive the first and second string winding wheels 331, 332 to coil the pulling strings 53, 54 respectively. If the user controls the blind vane 52 to reach a predetermined height, the push rod 362 can be released to allow the latch member 361 to press the pulling strings 53, 54 again and prevent the pulling strings 53, 54 from moving, so as to complete the process of scrolling the blind vane 52.

The structural design of the string coiler 30 of the Window coverings in accordance with the present invention is characterized in that if a user scrolls up or down the blind vane 52 of the Window coverings 50 by the string coiler 30, the first and second string winding wheels 331, 332 coupled to the first and second gears 321, 322 provide synchronous rotations by the synchronous control member 35 during rotations, and also drive the first and second string winding wheels 331, 332 to have a synchronous rotary speed, so that if the first and second string winding wheels 331, 332 are used for coiling or releasing the pulling strings 53, 54, the rotary speed of the first and second string winding wheels 331, 332 will be the same, so as to prevent the blind vane 52 from being tilted during the process of scrolling up or down the blind vane 52, and improve the decorative effect of the Window coverings 50 and the life of the Window coverings 50.

What is claimed is:

1. A Window coverings string coiler, comprising:
a hollow casing, having two corresponding protruding pillars therein, and forming an opening separately on both ends and a through hole disposed on a lateral side;
a gear set, having a first gear and a second gear respectively and pivotally coupled to two protruding pillars in the casing;
a string winding wheel set, separately coupled to the first gear and the second gear, and pivotally coupled to a first string winding wheel and a second string winding wheel of two protruding pillars, and the first and second string winding wheels separately forming a containing groove disposed at an internal side of the first and second string winding wheels;
two resilient plates, separately disposed in the containing grooves of the first and second string winding wheels, and the resilient plate having a first embedding end to be fixed to an internal side of the containing groove and a second embedding end to be fixed to an internal side of the protruding pillar;
a synchronous control member, for connecting and controlling the first and second gears for a synchronous rotation; and
a control set, having a latch member, a push rod, and a spring, and the latch member is disposed between the first and second string winding wheels in the casing, and a latch portion is extended separately from both sides of the corresponding first and second string winding wheels, and the push rod is passed through the through hole of the casing for installing a spring and coupled to the latch member, and an end of the spring is connected to a latch member and another end of the spring presses against an internal side of the casing.

2. The Window coverings string coiler of claim 1, wherein the casing includes a pivot disposed between two corresponding protruding pillars, and the synchronous control member is a gear separately engaged with the first and second gears and pivotally coupled to the pivot of the casing.

3. The Window coverings string coiler of claim 1, wherein the synchronous control member are two mutually engaged gears, and the two gears are engaged with the first and second gears respectively, and the casing includes two corresponding pivots disposed between the two corresponding protruding pillars and pivotally coupled with the two gears.

4. The Window coverings string coiler of claim 1, wherein the synchronous control member is connected to a belt of the first and second gears.

5. The Window coverings string coiler of claim 1, wherein the casing includes a roller disposed separately on each lateral side of the first and second string winding wheels.

6. The Window coverings string coiler of claim 1, wherein the casing forms a positioning pillar disposed between the first and second string winding wheels, and the latch member forms a long penetrating hole thereon for passing the positioning pillar.

7. The Window coverings string coiler of claim 1, wherein the casing comprises an upper casing and a lower casing vertically engaged with each other.
